(19) United States
(12) Patent Application Publication
(10) Pub. No.: US 2013/0210439 A1
(43) Pub. Date: Aug. 15, 2013

(54) SYSTEM FOR TRANSMITTING SYSTEM INFORMATION OF LTE-BASED FEMTOCELL

(71) Applicants: Hyung Deug Bae, Daejeon (KR); Kyong Tak Cho, Daejeon (KR); Sang Chul Oh, Daejeon (KR); Jun Sik Kim, Daejeon (KR); Seung Que Lee, Daejeon (KR); Nam Hoon Park, Daejeon (KR)

(72) Inventors: Hyung Deug Bae, Daejeon (KR); Kyong Tak Cho, Daejeon (KR); Sang Chul Oh, Daejeon (KR); Jun Sik Kim, Daejeon (KR); Seung Que Lee, Daejeon (KR); Nam Hoon Park, Daejeon (KR)

(73) Assignee: ELECTRONICS AND TELECOMMUNICATIONS RESEARCH INSTITUTE, Daejeon (KR)

(21) Appl. No.: 13/879,628

(22) PCT Filed: Oct. 21, 2011
(86) PCT No.: PCT/KR2011/007881

§ 371 Date: Apr. 16, 2013

(30) Foreign Application Priority Data
Oct. 22, 2010 (KR) 10-2010-0103397

(51) Int. Cl. H04W 56/00

(52) U.S. Cl. CPC H04W 56/00
USPC 455/436

(57) ABSTRACT

Provided are a mobile communication system comprising a femto base station for transmitting system information, and a terminal for receiving the system information from the femto base station. The terminal receives the system information from the femto base station, and during other times, receives data from a serving macro base station.

### TECHNICAL FIELD

The following embodiments relate to a mobile communication system, and more particularly, to a terminal for performing a handover from a serving macro base station to a femto base station, and a communication system including the terminal.

### BACKGROUND ART

A femto base station is a small base station, typically designed for use in a home or business. The femto base station has a very low transmission output level, and generally supports a small number of users. The femto base station may be operated in three connection modes, for example, an open mode, a closed mode, and a hybrid mode. In the open mode, the femto base station may be operated like a typical serving macro base station. A terminal may access the femto base station operated in the open mode, without any condition. A femto base station operated in the closed mode, or in a Closed Subscriber Group (CSG) mode may be accessed by only a terminal corresponding to a CSG Identifier (ID) of the femto base station. A femto base station operated in the hybrid mode is different from the femto base station operated in the CSG mode, in that the femto base station in the hybrid mode provides a service to even a terminal that does not correspond to a CSG ID of the femto base station in the hybrid mode. In general, a terminal corresponding to the CSG ID of the femto base station in the hybrid mode may have a high priority in terms of resource allocation and access control, compared to the terminal that does not correspond to the CSG ID of the femto base station in the hybrid mode.

To perform a handover from a serving macro base station to a femto base station operated in the closed mode or the hybrid mode, the terminal needs to read system information broadcasted by the femto base station, and needs to provide the serving macro base station with CSG information of the femto base station in the system information.

The system information may be divided into several System Information Blocks (SIBs), and may be periodically broadcasted based on each set time. The CSG information of the femto base station may be carried on a first SIB. A terminal may receive broadcast information of a femtocell, until the first SIB is successfully received.

When the broadcast information is being received, a terminal may be incapable of receiving a radio frame from a serving cell, and accordingly a loss of a traffic frame may occur.

### DISCLOSURE OF INVENTION

Technical Goals

An aspect of the present invention is to minimize a loss of data received from a serving macro base station during receiving of system information of a femto base station.

Another aspect of the present invention is to effectively receive system information of a femto base station.

Technical solutions

According to an aspect of the present invention, there is provided a terminal, including: a frame synchronization acquiring unit to acquire frame synchronization information of a femto base station; a control unit to acquire system information transmission time information included in a radio frame of the femto base station, based on the frame synchronization information; and a receiving unit to receive system information of the femto base station, based on the system information transmission time information.

The control unit may determine a time interval in which the system information is transmitted, based on the system information transmission time information, and the receiving unit may receive the system information during the time interval in which the system information is transmitted.

The receiving unit may receive data from a serving macro base station during a time interval in which the system information is not transmitted.

The control unit may receive Master Information Block (MIB) information from the femto base station, based on the frame synchronization information, may extract, from the received MIB information, a System Frame Number (SFN) of a radio frame, and may acquire the system information transmission time information using the extracted SFN.

The radio frame may include a plurality of subframes. When the radio frame has an even SFN, the control unit may acquire a time interval in which a fifth subframe among the plurality of subframes is transmitted, as the system information transmission time information.

The receiving unit may receive a synchronizing signal from the femto base station, and the frame synchronization acquiring unit may determine a start point of a radio frame transmitted from the femto base station, based on the synchronizing signal, and may acquire the start point of the radio frame as the frame synchronization information.

The control unit may determine a time interval in which a subframe including an MIB in the radio frame is transmitted, based on the frame synchronization information, may decode the MIB based on the determined time interval, and may extract the system information transmission time information from the MIB.

When the control unit fails to decode the MIB, the control unit may determine a time interval in which a subframe including a second MIB is transmitted, based on the frame synchronization information, and may re-extract the system information transmission time information from the second MIB.

The control unit may determine a time interval in which a subframe including the system information in the radio frame is transmitted, based on the system information transmission time information, and may receive the system information based on the determined time interval.

According to another aspect of the present invention, there is provided a femto base station, including: a system information transmitter to transmit, to a terminal, a radio frame including system information of the femto base station; and a receiver.

The system information transmitter may assign an SFN to the radio frame and may transmit the radio frame with the SFN. The system information may be received using the SFN.

When the radio frame has an even SFN, the system information transmitter may transmit the radio frame including the system information.

The femto base station may further include a synchronizing signal transmitter to transmit a synchronizing signal to the terminal The radio frame may be received from the terminal using the synchronizing signal.

According to still another aspect of the present invention, there is provided a terminal, including: a time information extracting unit to extract information regarding a time interval in which system information is transmitted by a femto base station, from synchronization information of a radio frame received from the femto base station; and a receiving unit to receive the system information from the femto base station during the time interval in which the system information is transmitted, and to receive data from a serving macro base station during the other time intervals.

The radio frame may include a plurality of subframes. The time information extracting unit may determine a time interval in which a subframe including an MIB is transmitted, based on the synchronization information, may decode the MIB based on the determined time interval, and may extract, from the MIB, the information regarding the time interval in which the system information is transmitted.

The MIB may include an SFN of the radio frame. The time information extracting unit may extract the information regarding the time interval in which the system information is transmitted, based on whether the SFN is even or odd.

The terminal may further include a transmitting unit to transmit, to the serving macro base station, Closed Subscriber Group (CSG) information acquired from the system information.

### EFFECT OF THE INVENTION

According to embodiments, it is possible to minimize a loss of data received from a serving macro base station during receiving of system information of a femto base station.

Additionally, according to embodiments, it is possible to effectively receive system information of a femto base station.

### BRIEF DESCRIPTION OF DRAWINGS

FIG. 1 is a diagram illustrating a relationship between a serving macro base station and a femto base station.

FIG. 2 is a flowchart illustrating a process of preparing to perform a handover from a serving macrocell to a femtocell.

FIG. 3 is a diagram illustrating a structure of a downlink radio frame including system information transmitted from a femto base station.

FIG. 4 is a diagram illustrating an offset between downlink radio frames of a serving macro base station and downlink radio frames of a femto base station according to an embodiment.

FIG. 5 is a flowchart illustrating a process by which a terminal receives system information according to an embodiment.

FIG. 6 is a flowchart illustrating a process by a terminal receives a Master Information Block (MIB) according to another embodiment.

FIG. 7 is a diagram illustrating an example in which a radio frame is lost when a terminal receives an MIB, according to an embodiment.

FIG. 8 is a flowchart illustrating a process by which a terminal receives system information according to another embodiment.

FIG. 9 is a diagram illustrating an example in which a radio frame is lost when a terminal receives system information, according to an embodiment.

FIG. 10 is a block diagram illustrating a structure of a terminal according to an embodiment.

FIG. 11 is a block diagram illustrating a structure of a femto base station according to an embodiment.

FIG. 12 is a block diagram illustrating a structure of a terminal according to another embodiment.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

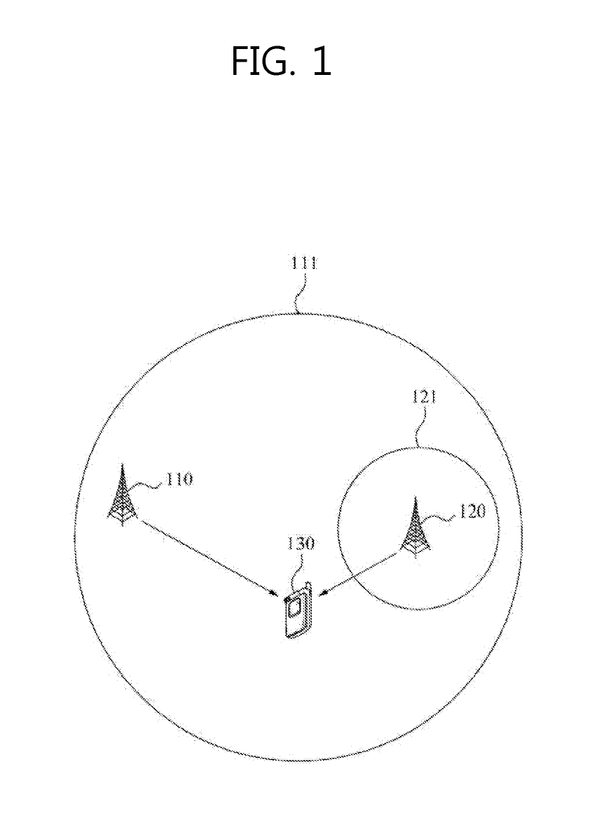

FIG. 1 is a diagram illustrating a relationship between a serving macro base station and a femto base station.

A serving macro base station 110 may transmit and receive data to or from a terminal 130 located within a coverage 111 of the serving macro base station 110. A femto base station 120 may be located within the coverage 111. The femto base station 120 may be installed to distribute traffics of the serving macro base station 110, or to provide unique services to limited terminals.

When the terminal 130 approaches a coverage 121 of the femto base station 120 within the coverage 111, the terminal 130 may perform a handover from the serving macro base station 110 to the femto base station 120.

The femto base station 120 may periodically broadcast system information of the femto base station 120, and the terminal 130 may receive the system information, so that the terminal 130 may perform the handover.

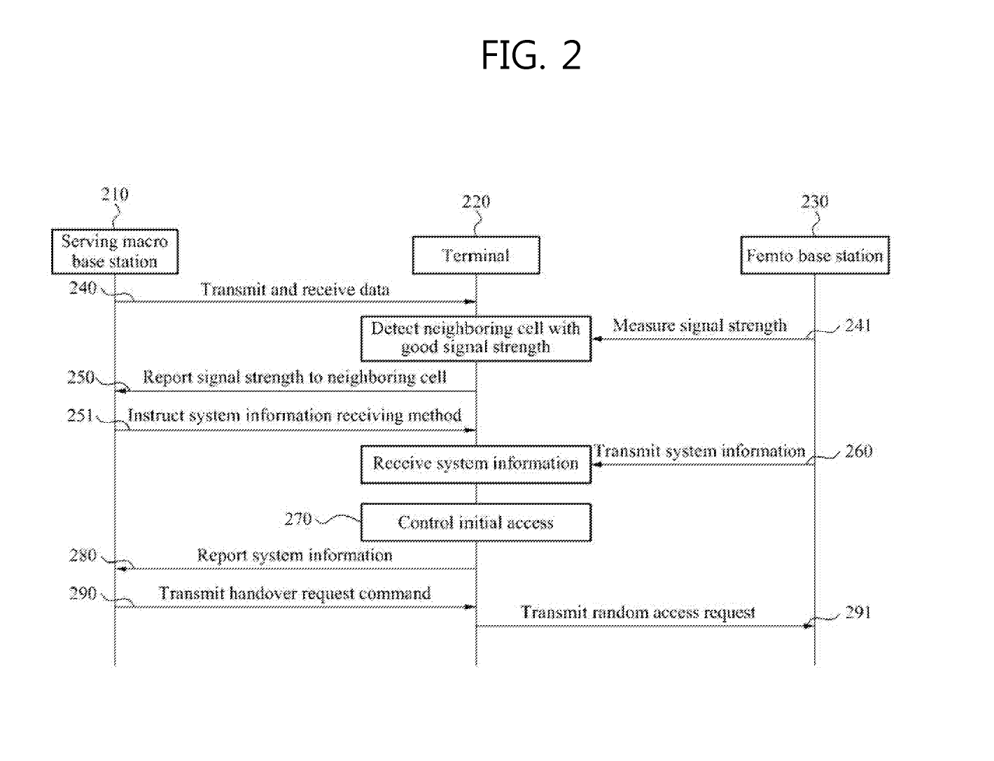

FIG. 2 is a flowchart illustrating a process of preparing to perform a handover from a serving macrocell to a femtocell.

In operation 240, a serving macro base station 210 may transmit or receive data to or from a terminal 220.

When the terminal 220 approaches a coverage of a femto base station 230, the terminal 220 may receive a pilot signal from the femto base station 230, may recognize the femto base station 230 based on the pilot signal, and may measure a received signal strength of the femto base station 230 in operation 241.

In operation 250, the terminal 220 may report, to the serving macro base station 210, the measured signal strength, together with a fact that the femto base station 230 with a sufficient signal strength is detected.

For example, when a strength of the pilot signal received from the femto base station 230 is equal to or greater than a predetermined threshold, the serving macro base station 210 may request the terminal 220 to send system information of the femto base station 230. In this example, the serving macro base station 210 may instruct the terminal 220 to perform a system information receiving method. As the system information receiving method, either a method of receiving information using gap allocation, or a method of automatically receiving information may be selected.

The method of automatically receiving information may enable the terminal 220 to set a predetermined time, and to receive the system information of the femto base station 230. The method of receiving information using gap allocation may enable the terminal 220 to receive the system information of the femto base station 230 in a period of time allocated by the serving macro base station 210.

In operation 260, the terminal 220 may receive the system information of the femto base station 230, based on the system information receiving method instructed by the serving macro base station 210. Since the terminal 220 is incapable of receiving data from the serving macro base station 210 while receiving the system information of the femto base station 230, a data packet may be lost, and a service used by the terminal 220 may be blocked.

In operation 270, the terminal 220 may control an initial access, based on the system information of the femto base station 230. The controlling of the initial access may refer to a process by which the terminal 220 compares its list of Closed Subscriber Group (CSG) identifiers (IDs) stored in a Universal Subscriber Identity Module (USIM) chip, with a CSG ID included in the system information of the femto base station 230, and determines whether registration of the terminal 220 in the femto base station 230 is enabled. When the CSG ID of the femto base station 230 is included in the CSG ID list of the terminal 220, the terminal 220 may be determined to belong to the femto base station 230, and otherwise, determined not to belong to the femto base station 230. Only a registrable terminal may be allowed to perform a handover to the femto base station 230 operated in a CSG mode. In a hybrid mode, the femto base station 230 may allow both a nonregistrable terminal and the registrable terminal to perform a handover, however, may give a benefit to the registrable terminal in terms of resource allocation.

When the controlling of the initial access is completed, the terminal 220 may report the received system information of the femto base station 230 to the serving macro base station 210 in operation 280.

In operation 290, the serving macro base station 210 may transmit a handover request command, based on the reported system information.

In operation 291, the terminal 220 may transmit a random access request to the femto base station 230, in response to the handover request command.

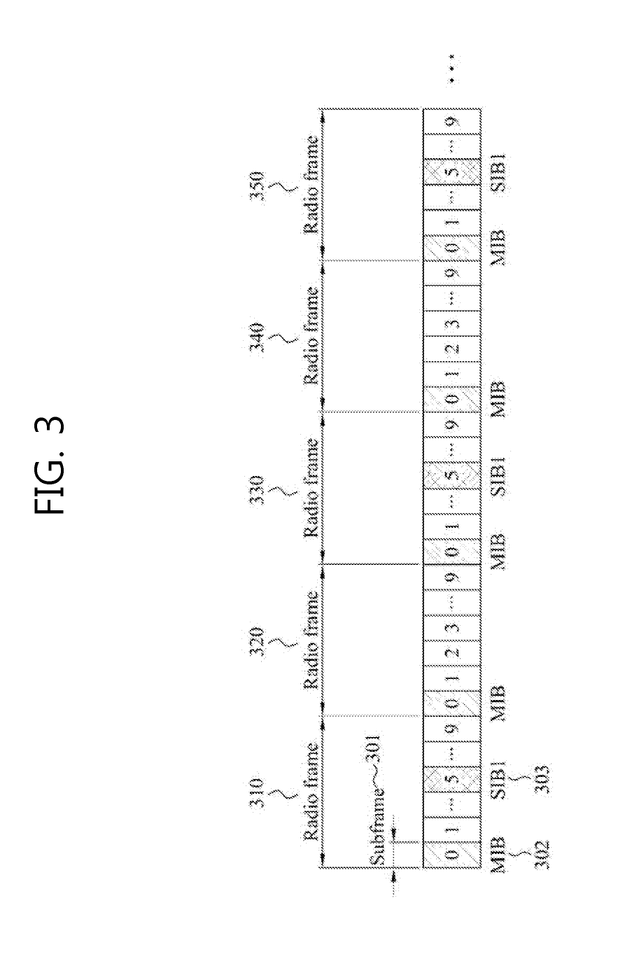

FIG. 3 is a diagram illustrating a structure of a downlink radio frame including system information transmitted from a femto base station.

The femto base station may transmit, to a terminal, radio frames 310, 320, 330, 340, and 350 at regular intervals. The femto base station may assign System Frame Numbers (SFNs) sequentially starting from 0 to radio frames, respectively, may insert each of the SFNs in a Master Information Block (MIB) of each of the radio frames, and may transmit the radio frames. A single radio frame may include several subframes, and numbers starting from 0 may be sequentially assigned to the subframes in the single radio frame.

The femto base station may carry, on a subframe 301, a user traffic packet and a signal packet to be transmitted to the terminal. An MIB 302 may be transmitted at a fixed interval to subframe #0, namely, a first subframe of all of the radio frames 310, 320, 330, 340, and 350. In other words, the MIB 302 may be transmitted to subframe #0 of the radio frame 310. A System Information Block-1 (SIB 1) 303 used to transmit system information of the femto base station may be transmitted to subframe #5 of a radio frame with an even SFN.

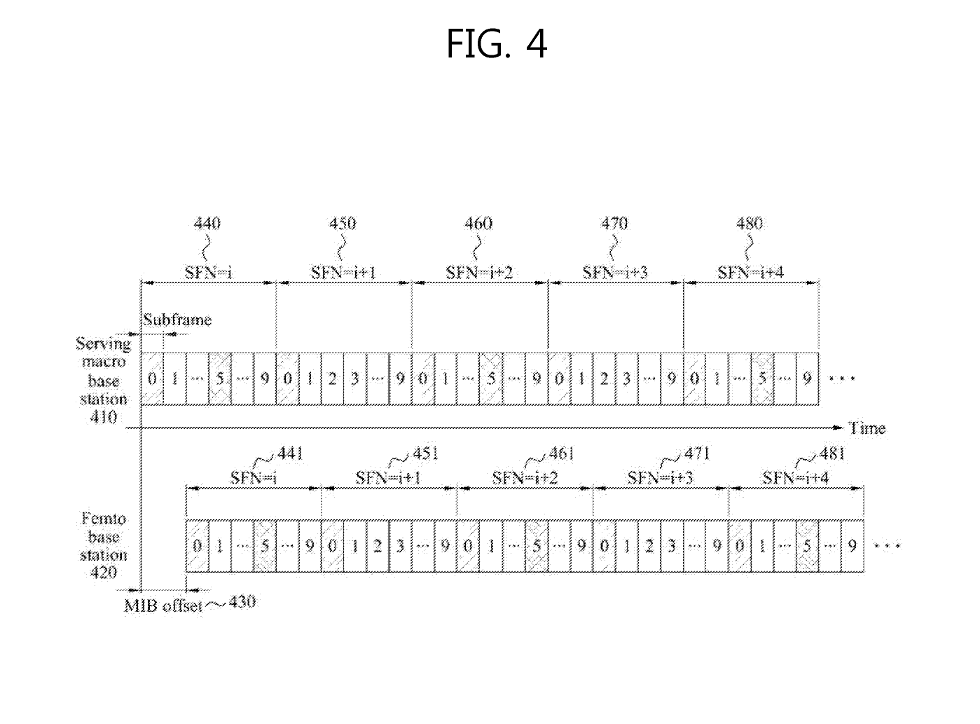

FIG. 4 is a diagram illustrating an offset between downlink radio frames of a serving macro base station and downlink radio frames of a femto base station according to an embodiment.

Since a Long Term Evolution (LTE) system is an asynchronous system, radio frames are not synchronized between base stations. In the LTE system, radio frames 440, 450, 460, 470, and 480 received from a serving macro base station 410 may differ in reception time from radio frames 441, 451, 461, 471, and 481 received from a femto base station 420. In the present specification, a difference in the reception time may be referred to as an MIB offset 430.

For example, when a terminal is aware of the MIB offset 430, it can be found that a radio frame received from the femto base station 420 may be started after the MIB offset 430 from a start time of a radio frame received from the serving macro base station 410. Accordingly, the terminal may easily verify a position of a subframe with an MIB in a radio frame received from the femto base station.

An SIB with system information of the femto base station may be transmitted to a fifth subframe of a radio frames with an even SFN. Accordingly, when MIB information is successfully received in a radio frame received from the femto base station, the terminal may compute a position of a subframe with an SIB received from the femto base station.

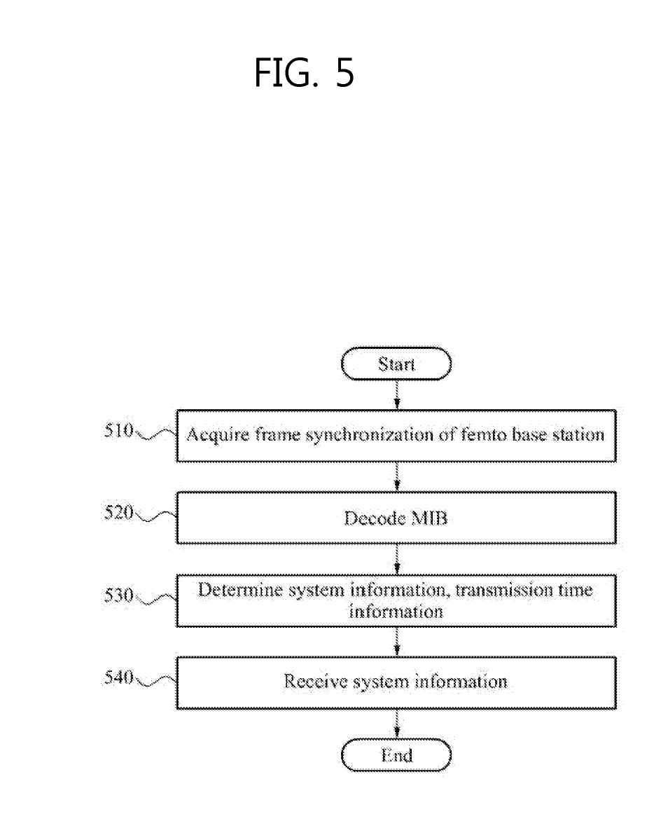

FIG. 5 is a flowchart illustrating a process by which a terminal receives system information according to an embodiment.

In operation 510, the terminal may acquire a start point of a radio frame received from a femto base station. The start point of the radio frame may be identical to a start point of a Physical-Synchronization Channel (P-SCH). Accordingly, the terminal may receive the P-SCH from the femto base station, and may acquire the start point of the radio frame by monitoring the received P-SCH.

When the start point of the radio frame is acquired, the terminal may receive a subframe with an MIB from the femto base station during an MIB broadcast time in operation 520, since the terminal is aware of a time interval in which the subframe with the MIB is broadcasted.

The subframe with the MIB may include an SFN of a radio frame. Accordingly, when the subframe with the MIB is successfully received, the terminal may acquire the SFN in operation 530. Additionally, the terminal may calculate an SIB broadcast time of the femto base station, using the SFN.

In operation 540, the terminal may receive a subframe with an SIB of the femto base station when an SIB is broadcasted. The terminal may receive a subframe from the femto base station, only during the MIB broadcast time and the SIB broadcast time, and may receive a data packet from the serving macro base station during the other time. Accordingly, it is possible to prevent the data packet from being lost, and to minimize a period of time during which a service used by the terminal is blocked.

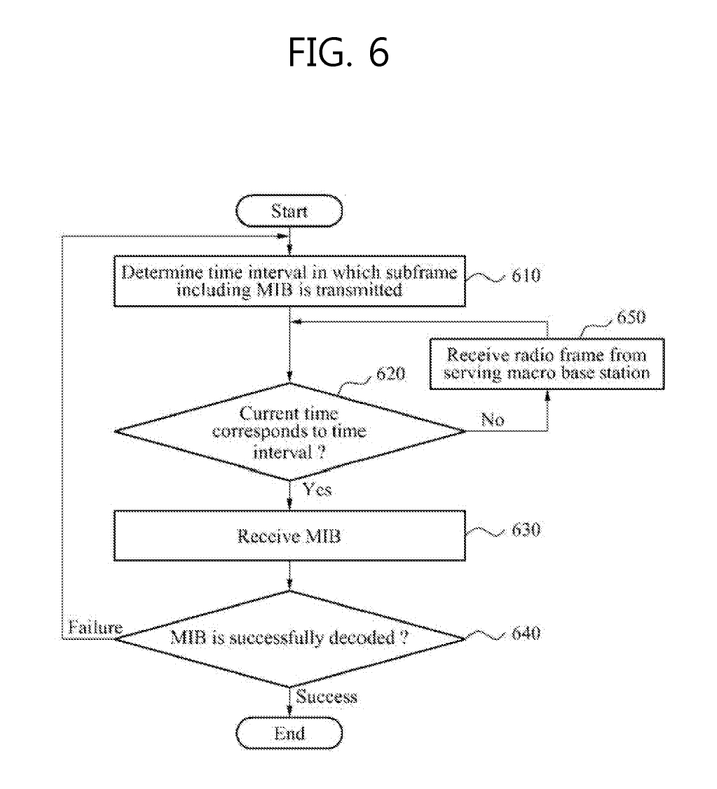

FIG. 6 is a flowchart illustrating a process by a terminal receives an MIB according to another embodiment.

In operation 610, the terminal may determine a time interval in which a subframe including an MIB is transmitted from a femto base station. According to an aspect, the subframe including the MIB may be transmitted at the same time in which each radio frame is started. Additionally, the terminal may monitor a P-SCH received from the femto base station, and may determine a start point of a radio frame.

In operation 620, the terminal may determine whether a current time corresponds to the time interval in which the subframe including the MIB is transmitted.

For example, when the current time corresponds to the time interval in which the subframe including the MIB is transmitted, the terminal may receive the subframe including the MIB from the femto base station in operation 630.

When the terminal fails to decode the MIB, the terminal may redetermine the time interval in which the subframe including the MIB is transmitted in operation 610.

When the current time does not correspond to the time interval in which the subframe including the MIB is transmitted, the terminal may receive a radio frame including a data packet from a serving macro base station in operation 650.

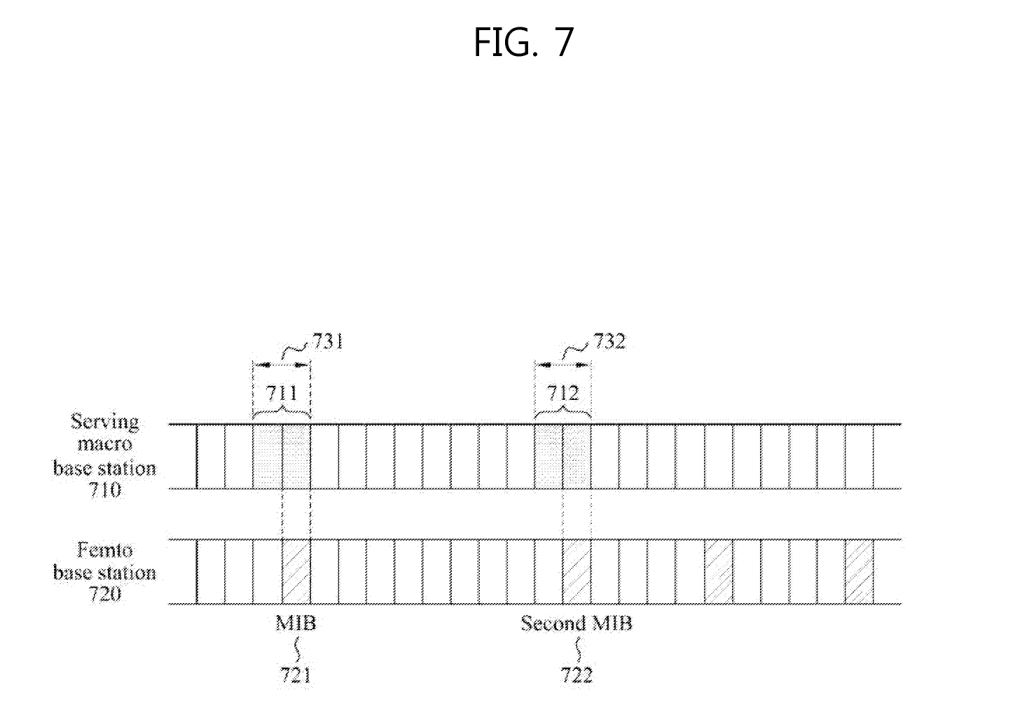

FIG. 7 is a diagram illustrating an example in which a radio frame is lost when a terminal receives an MIB, according to an embodiment.

The terminal may receive a subframe from a serving macro base station 710. When a current time corresponds to a time interval in which a subframe including an MIB 721 is transmitted from a femto base station 720, the terminal may interrupt receiving of the subframe from the serving macro base station 710. The terminal may receive the subframe including the MIB 721. During a time interval 731, the terminal may not receive a subframe 711 from the serving macro base station 710. In other words, during the time interval 731, a service used by the terminal may be blocked.

When receiving of the subframe including the MIB 721 is completed, the terminal may again receive a radio frame including a data packet from the serving macro base station 710.

For example, when the terminal fails to decode MIB information at a first attempt, the terminal may receive a subframe including a second MIB 722. When a current time corresponds to a time interval in which the subframe including the second MIB 722 is received, the terminal may interrupt receiving of a subframe 712 from the serving macro base station 710, and may attempt to receive the subframe including the second MIB 722. Similarly, during a time interval 732, the terminal may not receive the subframe 712 from the serving macro base station 710, and a service used by the terminal may be blocked.

As described above with reference to FIG. 7, the terminal may attempt to receive a subframe only during a specific time interval, rather than continuously attempting to receive a subframe from the femto base station. Accordingly, a period of time in which the terminal is incapable of receiving a data packet from the serving macro base station may be minimized, thereby minimizing a period of time during which the service is blocked.

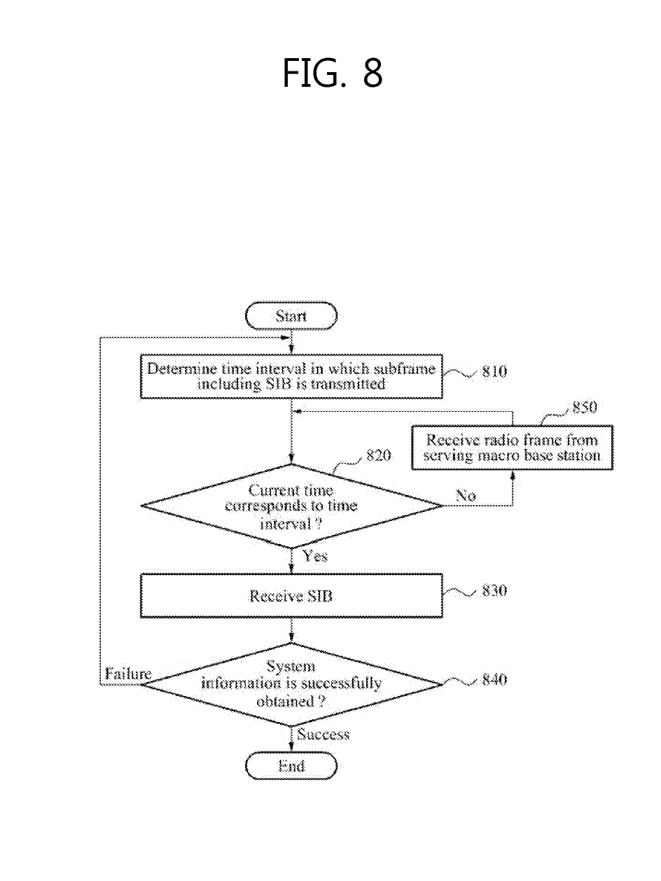

FIG. 8 is a flowchart illustrating a process by which a terminal receives system information according to another embodiment.

In operation 810, the terminal may acquire MIB information of a femto base station, and may calculate, using the MIB information, a time interval in which a subframe including an SIB is transmitted from a femto base station. According to an aspect, SIB information may be transmitted to a fifth subframe of a radio frame with an even SFN. Additionally, the terminal may calculate a time to receive the subframe including the SIB, using an SFN of a radio frame included in the MIB information.

In operation 820, the terminal may periodically determine whether a current time corresponds to a time interval in which an SIB is received.

When the current time corresponds to the time interval in which the SIB is received, the terminal may receive the SIB from the femto base station in operation 830. When the current time does not correspond to the time interval in which the SIB is received, the terminal may receive a radio frame including a data packet from a serving macro base station in operation 850.

In operation 840, the terminal may determine whether system information is successfully obtained by successfully decoding the system information.

When the system information is not successfully decoded, the terminal may recalculate the time interval in which the subframe including the SIB is received in operation 810.

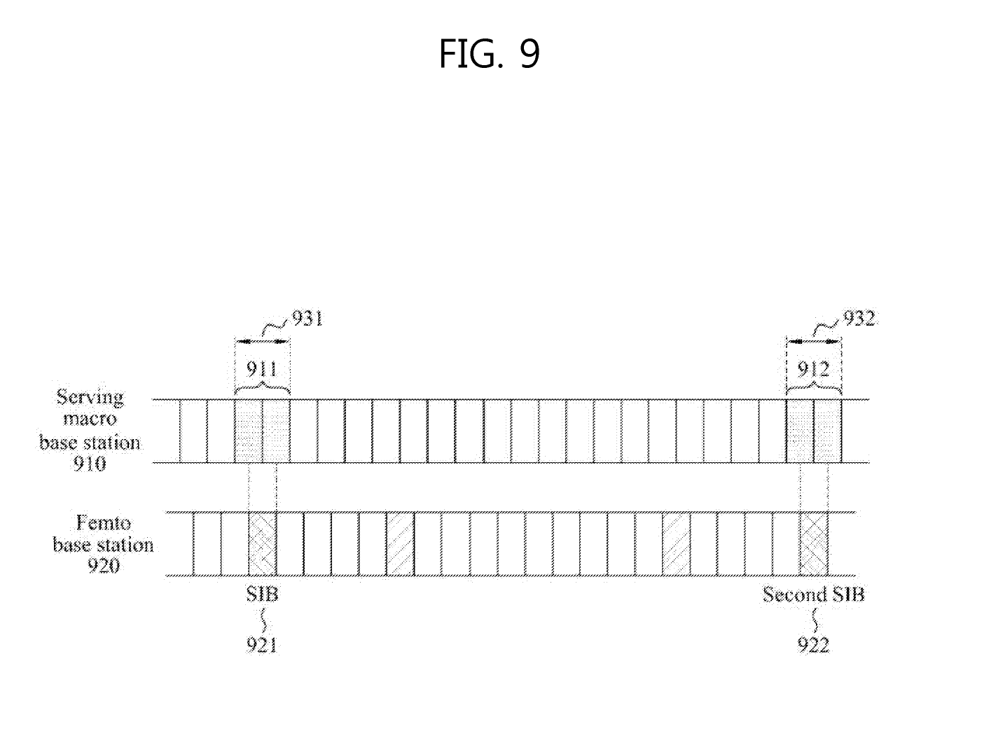

FIG. 9 is a diagram illustrating an example in which a radio frame is lost when a terminal receives system information, according to an embodiment.

The terminal may receive a subframe from a serving macro base station 910. When a current time corresponds to a time interval in which a subframe including an SIB 921 is transmitted from a femto base station 920, the terminal may interrupt receiving of the subframe from the serving macro base station 910. The terminal may receive the subframe including the SIB 921 from the femto base station 920. During a time interval 931, the terminal may not receive a subframe 911 from the serving macro base station 910. In other words, during the time interval 931, a service used by the terminal may be blocked.

When receiving of the subframe including the SIB 921 is completed, the terminal may again receive a radio frame including a data packet from the serving macro base station 910.

For example, when the terminal fails to decode SIB information at a first attempt, the terminal may receive a next subframe including a second SIB 922. When a current time corresponds to a time interval in which the subframe including the second SIB 922 is received, the terminal may interrupt receiving of a subframe 912 from the serving macro base station 910, and may attempt to receive the subframe including the second SIB 922. Similarly, during a time interval 932, the terminal may not receive the subframe 912 from the serving macro base station 910, and a service used by the terminal may be blocked.

As described above with reference to FIG. 9, the terminal may attempt to receive a subframe only during a specific time interval, rather than continuously attempting to receive a subframe from the femto base station. Accordingly, a period of time in which the terminal is incapable of receiving a data packet from the serving macro base station may be minimized, thereby minimizing a period of time during which the service is blocked.

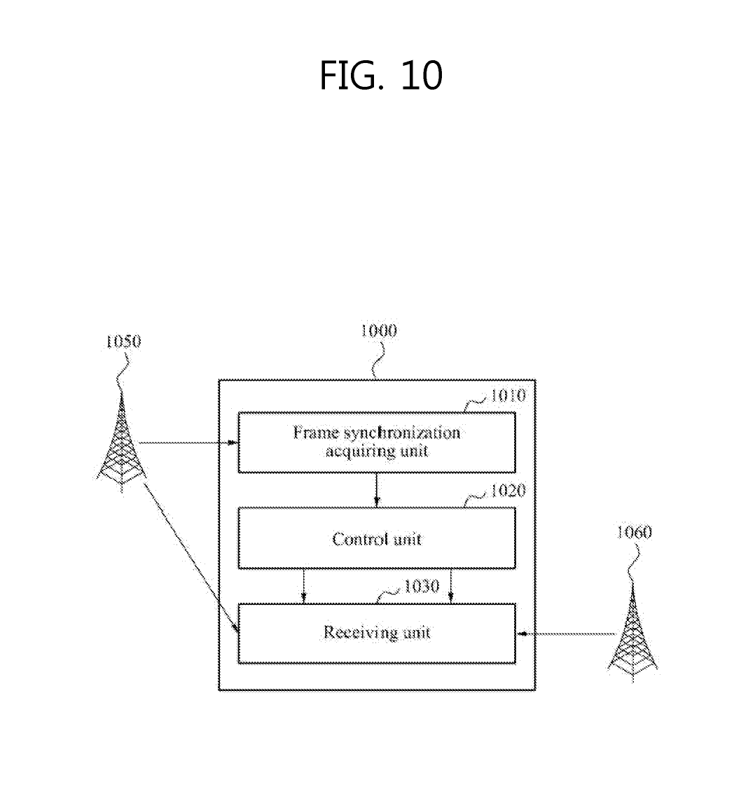

FIG. 10 is a block diagram illustrating a structure of a terminal according to an embodiment.

The terminal may include a frame synchronization acquiring unit 1010, a control unit 1020, and a receiving unit 1030.

The frame synchronization acquiring unit 1010 may acquire frame synchronization information of a femto base station 1050. According to an aspect, a start point of a radio frame may be identical to a start point of a P-SCH. Accordingly, the receiving unit 1030 may receive a synchronizing signal from the femto base station 1050, and the frame synchronization acquiring unit 1010 may determine, based on the synchronizing signal, a start point of a radio frame transmitted from the femto base station 1050, and may acquire the start point of the radio frame as frame synchronization information.

According to an aspect, the synchronizing signal may be transmitted using the P-SCH.

The control unit 1020 may acquire system information transmission time information included in a radio frame of the femto base station 1050, based on the frame synchronization information. According to an aspect, a radio frame transmitted by the femto base station 1050 may include a plurality of subframes. System information of the femto base station 1050 may be included in a specific subframe among the plurality of subframes transmitted by the femto base station 1050. In this instance, the system information transmission time information may refer to information regarding a time interval in which the specific subframe including the system information is transmitted.

According to an aspect, the system information of the femto base station 1050 may be included in a fifth subframe of a radio frame with an even SFN. In this instance, the control unit 1020 may obtain, as system information transmission time information, the information regarding the time interval in which the specific subframe including the system information is transmitted, using a start point and the SFN of the radio frame.

According to an aspect, the control unit 1020 may determine, based on the frame synchronization information, a time interval in which a subframe including an MIB is transmitted by the femto base station 1050, and may decode the MIB based on the determined time interval. The control unit 1020 may extract an SFN from the MIB. Additionally, the control unit 1020 may extract system information transmission time information using the SFN.

According to an aspect, an MIB transmitted by the femto base station 1050 may be included in a first subframe among a plurality of subframes included in each radio frame. In this instance, the control unit 1020 may decode the first subframe among the plurality of subframes, may acquire an SFN of a radio frame, and may obtain information regarding a time interval in which a specific subframe including system information is transmitted, using the acquired SFN.

The receiving unit 1030 may receive the system information of the femto base station 1050, based on the system information transmission time information. According to an aspect, the control unit 1020 may determine a time interval in which the system information is transmitted, based on the system information transmission time information. In other words, the time interval in which the system information is transmitted may refer to a time interval in which a specific subframe including the system information is transmitted. In this instance, the receiving unit 1030 may receive the system information from the femto base station 1050 during the time interval in which the system information is transmitted.

Additionally, the receiving unit 1030 may receive data from a serving macro base station 1060. During a time interval in which the system information is received from the femto base station 1050, the receiving unit 1030 may not receive the data from the serving macro base station 1060. During the other time intervals, the receiving unit 1030 may be activated to receive the data from the serving macro base station 1060. In other words, the receiving unit 1030 may be inactivated during the time interval in which the system information is transmitted, and may be activated to receive the data from the serving macro base station 1060 during a time interval in which the system information is not transmitted.

When the control unit 1020 fails to decode the MIB, the control unit 1020 may redetermine a time interval in which a subframe including a second MIB is transmitted, based on the frame synchronization information. The control unit 1020 may re-extract system information transmission time information from the second MIB.

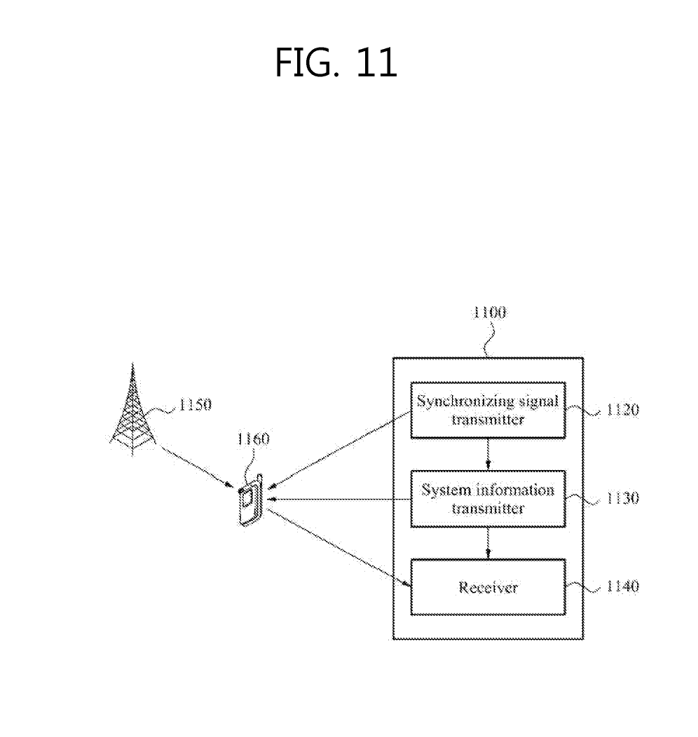

FIG. 11 is a block diagram illustrating a structure of a femto base station according to an embodiment. A femto base station 1100 may include a synchronizing signal transmitter 1120, a system information transmitter 1130, and a receiver 1140.

The synchronizing signal transmitter 1120 may transmit a synchronizing signal to a terminal 1160. According to an aspect, a start point of a radio frame transmitted by the femto base station 1100 may be identical to a start point of the synchronizing signal. In this instance, the terminal 1160 may determine the start point of the radio frame based on the start point of the synchronizing signal, and may receive the radio frame.

The system information transmitter 1130 may transmit system information to the terminal 1160. According to an aspect, the system information transmitter 1130 may transmit, to the terminal 1160, a radio frame including the system information. The terminal 1160 may access the femto base station 1100 based on the system information. According to an aspect, the terminal 1160 may receive data from a serving macro base station 1150. In this instance, the terminal 1160 may receive the system information from the system information transmitter 1130 during a time interval in which the system information transmitter 1130 transmits the system information, and may receive the data from the serving macro base station 1150 during the other time intervals.

According to an aspect, the system information transmitter 1130 may insert the system information in only a specific radio frame among a plurality of radio frames, and may transmit the system information. The system information transmitter 1130 may assign an SFN to each radio frame, and may transmit each radio frame with the assigned SFN. In this instance, the terminal 1160 may receive the system information using the SFN.

According to an aspect, the system information transmitter 1130 may insert the system information in only a radio frame with an even SFN and may transmit the system information. In this instance, the terminal 1160 may verify the SFN of the radio frame, and may determine a time interval in which the system information is transmitted, based on the SFN.

When the terminal 1160 accesses the femto base station 1100 based on the system information, the receiver 1140 may receive, from the terminal 1160, a random access request generated based on the system information.

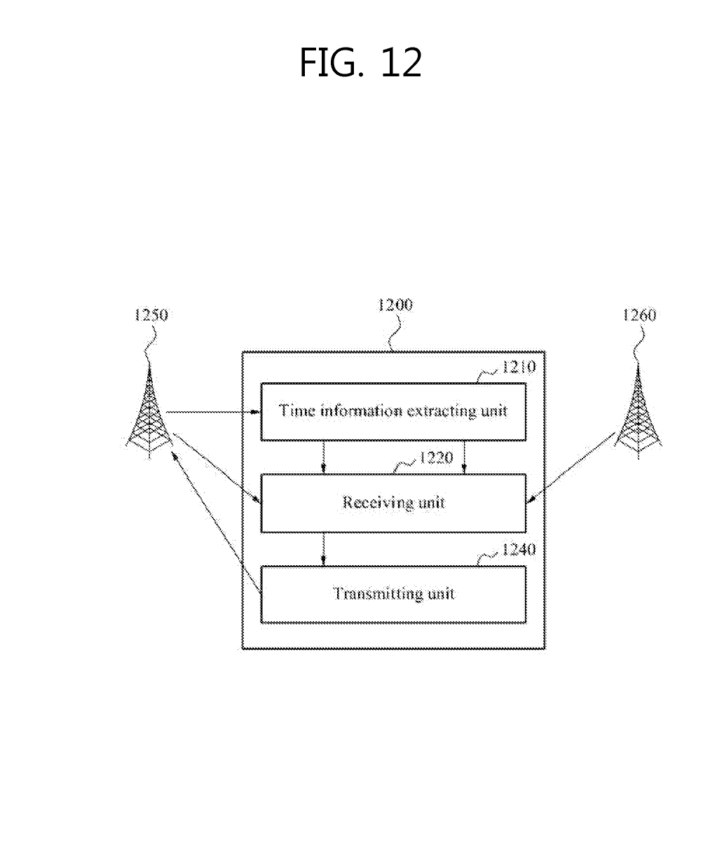

FIG. 12 is a block diagram illustrating a structure of a terminal according to another embodiment.

A terminal 1200 may include a time information extracting unit 1210, a receiving unit 1220, and a transmitting unit 1240.

The time information extracting unit 1210 may extract information regarding a time interval in which system information is transmitted by a femto base station 1250, from synchronization information of a radio frame received from the femto base station 1250. According to an aspect, the time information extracting unit 1210 may receive a P-SCH from the femto base station 1250, and may extract the synchronization information, using a synchronizing signal included in the P-SCH.

The femto base station 1250 may transmit an SFN of the radio frame by inserting the SFN in an MIB. The time information extracting unit 1210 may determine a time interval in which a subframe including the MIB in the radio frame is transmitted, using the synchronization information. The time information extracting unit 1210 may decode the MIB, based on the determined time interval. The MIB may include frame information regarding the radio frame. The time information extracting unit 1210 may determine, using the SFN included in the MIB, whether the received radio frame includes system information.

According to an aspect, the femto base station 1250 may insert system information of the femto base station 1250 in a fifth subframe of a radio frame with an even SFN, and may transmit the radio frame. In this instance, the time information extracting unit 1210 may determine, using the SFN of the radio frame, whether the received radio frame includes the system information.

Additionally, the time information extracting unit 1210 may extract information regarding a time interval in which a subframe including the system information in the radio frame is transmitted, using the SFN and synchronization information of the radio frame. The time information extracting unit 1210 may extract, as system information transmission time information, the information regarding the time interval in which the subframe including the system information is transmitted.

The receiving unit 1220 may be activated to receive the system information from the femto base station 1250, only during the time interval in which the system information is transmitted.

Additionally, the receiving unit 1220 may not receive data from a serving macro base station 1260 during the time interval in which the system information is transmitted, and may be activated to receive data from the serving macro base station 1260 during the other time intervals.

When the receiving unit 1220 successfully receives the system information of the femto base station 1250, the terminal 1200 may extract CSG information from the system information of the femto base station 1250, and may transmit the extracted CSG information to the serving macro base station 1260.

The serving macro base station 1260 may determine whether to allow the terminal 1200 to perform a handover to the femto base station 1250, based on the CSG information of the femto base station 1250. According to an aspect, the serving macro base station 1260 may transmit a handover request command to the terminal 1200, and the terminal 1200 may transmit a random access request to the femto base station 1250 in response to the handover request command.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A terminal, comprising:
a frame synchronization acquiring unit to acquire frame synchronization information of a femto base station;
a control unit to acquire system information transmission time information included in a radio frame of the femto base station, based on the frame synchronization information; and
a receiving unit to receive system information of the femto base station, based on the system information transmission time information.

2. The terminal of claim 1, wherein the control unit determines a time interval in which the system information is transmitted, based on the system information transmission time information, and
wherein the receiving unit receives the system information during the time interval in which the system information is transmitted.

3. The terminal of claim 2, wherein the receiving unit receives data from a serving macro base station during a time interval in which the system information is not transmitted.

4. The terminal of claim 1, wherein the control unit acquires Master Information Block (MIB) information based on the frame synchronization information, extracts, from the MIB information, a System Frame Number (SFN) of a radio frame received from the femto base station, and acquires the system information transmission time information using the extracted SFN.

5. The terminal of claim 4, wherein the radio frame comprises a plurality of subframes, and
wherein, when the radio frame has an even SFN, the control unit acquires a time interval in which a fifth subframe among the plurality of subframes is transmitted, as the system information transmission time information.

6. The terminal of claim 1, wherein the receiving unit receives a synchronizing signal from the femto base station, and
wherein the frame synchronization acquiring unit determines a start point of a radio frame transmitted from the femto base station, based on the synchronizing signal, and acquires the start point of the radio frame as the frame synchronization information.

7. The terminal of claim 6, wherein the control unit determines a time interval in which a subframe including an MIB in the radio frame is transmitted, based on the frame synchronization information, decodes the MIB based on the determined time interval, and extracts the system information transmission time information from the MIB.

8. The terminal of claim 7, wherein, when the control unit fails to decode the MIB, the control unit determines a time interval in which a subframe including a second MIB is transmitted, based on the frame synchronization information, and re-extracts the system information transmission time information from the second MIB.

9. The terminal of claim 7, wherein the control unit determines a time interval in which a subframe including the system information in the radio frame is transmitted, based on the system information transmission time information, and receives the system information based on the determined time interval.

10. A femto base station, comprising:
a system information transmitter to transmit, to a terminal, a radio frame including system information of the femto base station; and
a receiver.

11. The femto base station of claim 10, wherein the system information transmitter assigns a System Frame Number (SFN) to the radio frame and transmits the radio frame with the SFN, and
wherein the system information is received using the SFN.

12. The femto base station of claim 11, wherein, when the radio frame has an even SFN, the system information transmitter transmits the radio frame including the system information.

13. The femto base station of claim 10, further comprising:
a synchronizing signal transmitter to transmit a synchronizing signal to the terminal,
wherein the radio frame is received from the terminal using the synchronizing signal.

14. A terminal, comprising:
a time information extracting unit to extract information regarding a time interval in which system information is transmitted by a femto base station, from synchronization information of a radio frame received from the femto base station; and
a receiving unit to receive the system information from the femto base station during the time interval in which the system information is transmitted, and to receive data from a serving macro base station during the other time intervals.

15. The terminal of claim 14, wherein the radio frame comprises a plurality of subframes, and
wherein the time information extracting unit determines a time interval in which a subframe including a Master Information Block (MIB) is transmitted, based on the synchronization information, decodes the MIB based on the determined time interval, and extracts, from the MIB, the information regarding the time interval in which the system information is transmitted.

16. The terminal of claim 15, wherein the MIB comprises a System Frame Number (SFN) of the radio frame, and
wherein the time information extracting unit extracts the information regarding the time interval in which the system information is transmitted, based on whether the SFN is even or odd.
